(19) United States
(12) Patent Application Publication
(10) Pub. No.: US 2001/0008320 A1
(43) Pub. Date: Jul. 19, 2001

(54) METHOD FOR MOLDING A GOLF BALL MANTLE LAYER

(76) Inventor: STEPHEN K. SCOLAMIERO, BRIDGEWATER, MA (US)

Correspondence Address: PENNIE & EDMONDS LLP, 1667 K STREET NW, SUITE 1000, WASHINGTON, DC, 20006

(21) Appl. No.: 09/215,223

(22) Filed: Dec. 18, 1998

(51) Int. Cl. B29C 43/18; B29C 45/14

(52) U.S. Cl. 264/250; 264/254; 264/255; 264/248; 264/279.1

(57) ABSTRACT

A method for molding a layer around a body. The method includes injection molding uncured layer material around a first portion of the body to surround the first portion while leaving a second portion of the body free from layer material. Additional layer material is injection molded around the second portion of the body to contact the layer material around the first portion. The layer material is then compression molded around the body and cured.

### BACKGROUND OF THE INVENTION

Golf balls are typically comprised of a cover that is injection molded or compression molded around a golf ball core, which may include one or more wound or solid layers and also a liquid or solid center. Solid golf ball cores are typically a polybutadiene sphere, but may include one or more mantle layers, each selected to produce desired play characteristics of the ball. Each layer of the core is generally either compression or injection molded around the inner layers.

A known method of producing a mantle layer around a golf ball center is to first place sheets of uncured rubber material over two hemispherical mold cavities. A center is pushed into one of the sheets covering one of the cavities, causing the sheet to deform into the cavity. The two mold cavities are then brought together around the center, forcing the other sheet to similarly deform into the other cavity, forming a concentric shell around the center. The shell, with the center, is removed from the cavities, and a compression molding operation is carried out to crosslink the rubber material from the two sheets.

Traditionally, mantle layers of a golf ball core have also been made by separately injection molding and solidifying half shells of uncured rubber material and then bringing them together around a center. Crosslinking between the half shells is again achieved in a subsequent compression molding operation.

Certain uncured materials, however, such as uncured polybutadiene, are not sufficiently stable at room temperatures to form half shells. These materials are flowable to a degree even at room temperature. Their viscosity at room temperature is generally high, but decreases as their temperature is raised. These materials are typically injection molded directly around a center, which is supported on fixed or retractable pins, and cured within the injection mold.

U.S. Pat. No. 5,006,297 shows a method of molding a golf ball cover, instead of a mantle layer, about a core. Flowable cover stock is introduced into open mold halves. The core is pressed into the cover stock and is supported by pins protruding from the mold halves. The mold halves are closed about the core, and before the cover stock cures entirely, the ball is transferred to a compression mold in which it is compression molded with a dimple pattern. Timing is critical in this method as the cover stock must not be allowed to cure excessively or too little before the compression molding step.

U.S. Pat. No. 2,940,128 teaches another method of injection molding covered rubber balls. A core is held in a holding plate while a resilient material is injected about a half of the core within a cavity of a metal plate. Then the holding plate is removed, and resilient material is injected about the other half of the core in a cavity of another metal plate. The material is cured in the cavities. As this method cures the cover material directly after being injection molded, the finish of and the crosslinking in the materials is diminished when compared to curing the material after compression molding. Notable discontinuities and residual stresses will exist across the weld lines in the cover, producing weak areas which may lead to early material failure after repeated use.

### SUMMARY OF THE INVENTION

The invention relates to a method for molding a layer around a body. Uncured or unvulcanized layer material is injection molded around a first portion of the body to surround this portion, but not a second portion of the body. Additional layer material is injection molded around the second portion of the body to contact the layer material that is disposed around the first portion. The layer material is then compression molded around the body and cured or vulcanized.

When the layer material is injection molded around the first portion of the body, the second portion of the body is held to properly locate the first portion in a first mold cavity. Once the layer material has been injection molded around the first portion and is sufficiently viscous to support the body in a substantially fixed position, the second portion is released and positioned within a second mold cavity. Then, the injection molding around this second portion is carried out.

This invention yields a thickness of the layer material that is easily controlled and easy to maintain consistent throughout many molding cycles. When manufacturing golf balls, this invention provides improved concentricity of a mantle layer, or other layer such as a cover, that is molded around a center or a core.

The injection molding of the uncured material sequentially around each portion of the body eliminates the requirement of using support pins, improving the knitting throughout the layer material because no weak spots are created at places from where any pins would have been retracted. The compression molding finally relieves a major proportion of internal stresses present within the layer material, while improving packing of the material in the features of the mold cavity.

### BRIEF DESCRIPTION OF THE DRAWINGS

FIG. 1 is a cross-sectional view of a multilayered golf ball;

FIG. 2 is a cross-sectional view of an injection molding apparatus constructed according to the invention, with a body held in an injection mold cavity;

FIG. 3 is a cross-sectional view of layer material being injection molded about a portion of the body;

FIG. 4 is a cross-sectional view of the body with the layer material placed in another injection mold cavity;

FIG. 5 is a cross-sectional view of layer material being injection molded about another portion of the body;

FIG. 6 is a cross-sectional view of a compression mold compression molding the layer material about the body;

FIG. 7 is a partial cross-sectional view of a compression mold setup for compression molding a golf ball cover around the layer material; and

FIG. 8 is a flow chart summarizing the preferred embodiment of the inventive method.

### DETAILED DESCRIPTION OF THE PREFERRED EMBODIMENTS

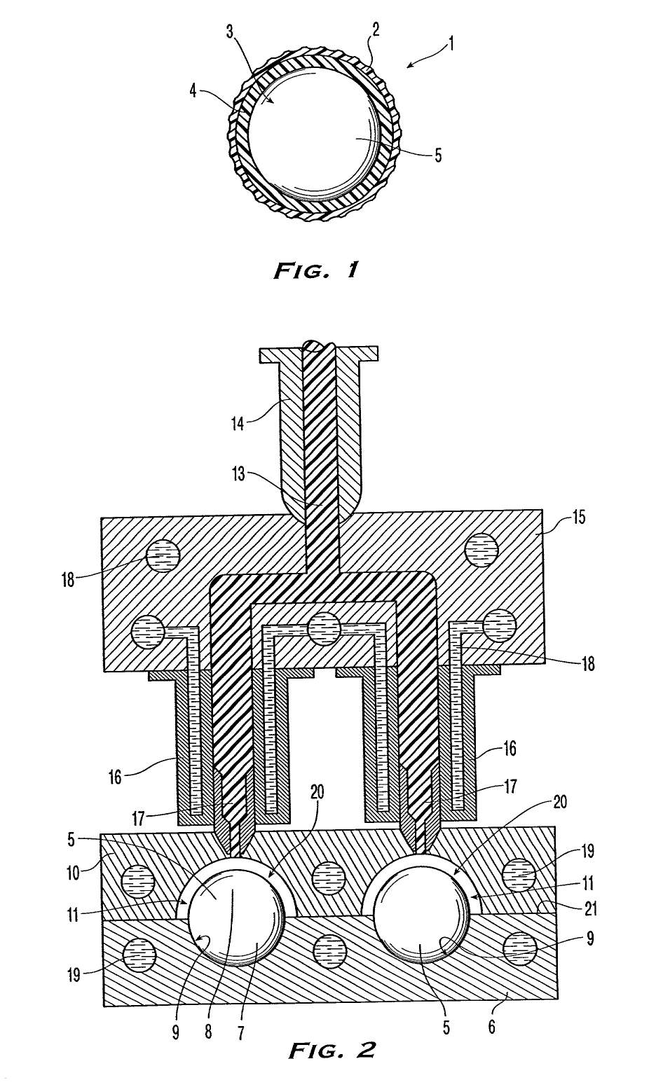

Referring to FIG. 1, multilayered golf ball 1 has cover 2 surrounding a core 3, which includes mantle layer 4 and center 5. Referring to FIGS. 2 and 8, a body, such as the golf ball center 5 or an inner layer of a golf ball core that has been formed with a substantially spherical shape, is held in a fixture 6. In a solid construction golf ball embodiment, the center 5 is preferably polybutadiene based and comprises zinc diacrylate and calcium oxide in an amount selected to control the ball compression. The center 5 may also include a central liquid filling, and one or more additional mantle layers.

The fixture 6 has a holding cavity 9 that is shaped to securely hold the center 5 by a lower portion 7 thereof. An upper portion 8 of the center 5 remains exposed from the fixture 6. Although various structures in the invention are described with the terms “upper” and “lower”, it will be understood that described orientation is preferred, but the orientation of the structures may be varied. Preferably, the holding cavity 9 has a diameter that is substantially the same as the diameter of the center 5, or sufficiently smaller than the center 5 diameter to keep the center 5 from falling out of the fixture 6 when suspended therefrom, so that the molding can be practiced with the fixture 6 disposed upside down over a mold cavity. A diameter of the holding cavity 9 that is undersized relative to the center 5 by less than about 0.008 inches has been found to hold and release the center 5 satisfactorily. Preferably the holding cavity 9 is undersized by about 0.005 inches. The center 5 also preferably fits in the holding cavity 9 such that any space remaining between the center 5 and the fixture 6 is effectively sealed to prevent penetration therein of layer material that is later injection molded adjacent the center 5 and the fixture 6.

An injection mold portion, preferably upper injection mold half 10, defines substantially hemispherical upper injection mold cavities 11. Each upper injection mold cavity 11 is placed substantially spherically concentrically with the center 5. The upper injection mold half 10 also includes at least one injection gate 12, through which mantle layer material 13, or other layer material including golf ball cover stock, can be injected into the upper injection mold cavity 11. Gates 12 are preferably located at a pole of the upper injection mold cavity 11, although alternative embodiments may provide a gate between the upper injection mold half 10 and the fixture 6, by providing a recess where they meet. The layer material 13 is preferably a polybutadiene based rubber material, which in an uncured state is flowable but viscous enough for handling without significant deformation.

An injection nozzle 14 is connected to a distribution manifold 15 to force layer material 13 therethrough. Runner drops 16 deliver layer material from the distribution manifold 15 to the upper injection mold cavities 11.

A cold runner system is preferably employed, in which the injection nozzle 14, distribution manifold 15, and runner drops 16 are maintained at a higher temperature than the upper injection mold half 10. At this higher temperature, which is preferably between about 150°F. and 200°F., and more preferably is about 180°F., layer material 13 remains uncured and is less viscous and more flowable than at the temperature in the upper injection mold half 10. The temperature of the upper injection mold half 10 is maintained low enough to render the layer material 13 sufficiently viscous to be handled and moved from one mold to another without significant deformation of the injection molded shape of the layer material 13. Preferably the upper injection mold half 10 temperature is below about 80°F. and more preferably is about 50°F. The flow of the hot layer material 13 may be positively stopped after the upper injection mold cavity 11 is filled, while maintaining the low viscosity of the layer material 13 in runners 17 that lead through the runner drops 16 to the upper injection mold half 10.

The temperature of the different components discussed is preferably controlled by flowing water therethrough. Hot water at 180°F. flows through passages 18 in the distribution manifold 15 and in the runner drops 16. Cool water at 50°F. flows through passages 19 in the upper injection mold half 10 and the fixture 6.

The upper injection mold half 10 is shown pressed tightly against the fixture 6, with the upper injection mold cavity 11 surrounding the upper portion 8 of the center 5. Preferably, a hydraulic press holds the fixture 6 and the upper injection mold half 10 together with a force of less than about 100 kN to about 200 kN for a molding machine designed to mold four individual golf ball cores, although the molding machine preferably molds from four to eight cores. In a four-core mold and with about 2500 psi cavity pressure, about a 100 kN force is used.

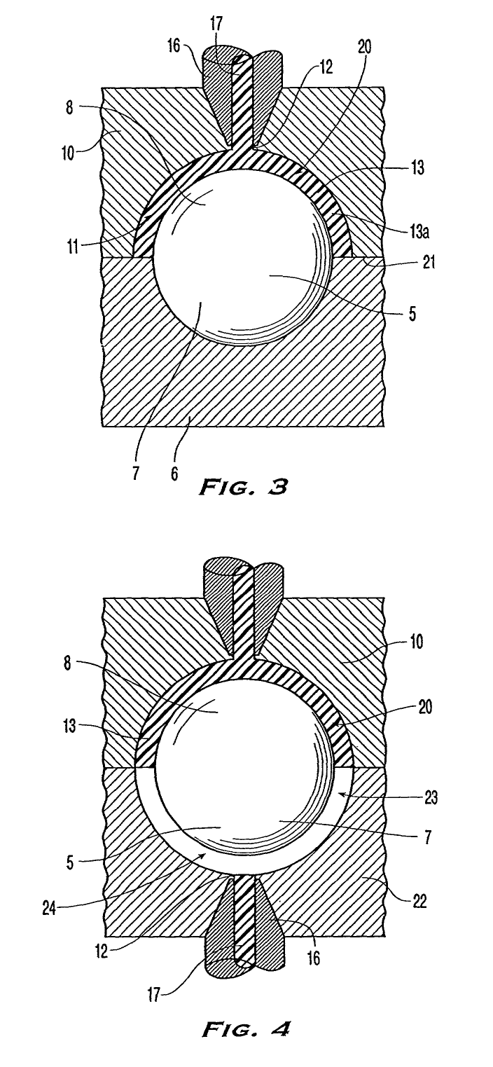

When the upper injection mold half 10 is pressed against the fixture 6, the upper injection mold cavity 11 is closed. Referring to FIG. 3, uncured layer material 13 is injected around the upper portion 8 of the center 5 into upper injection cavity space 20 in the upper injection mold cavity 11, between the upper injection mold half 10 and the upper portion 8 of the center 5, at a cavity 11 pressure of around 2500 psi, and preferably about 1500 to 5000 psi. Where the center 5 has a diameter of about 1.062 in. and the upper injection mold cavity 11 has a diameter of about 1.660 in., it preferably takes about 2.8 seconds to fill the upper injection mold cavity 11. The layer material 13 is prevented from flowing around the lower portion 7 of the center 5, thus leaving the lower portion 7 substantially free from layer material 13. As a result, the layer material 13 forms an upper hemisphere 13a between the upper injection mold half 10 and the center 5.

As the layer material 13 is injected, air that is contained within the upper injection cavity space 20 is vented through a relief 21 defined between the upper injection mold half 10 and the fixture 6. The relief 21 preferably has a depth of around 0.0008 inches. This depth permits air to vent but prevents the passage of layer material 13.

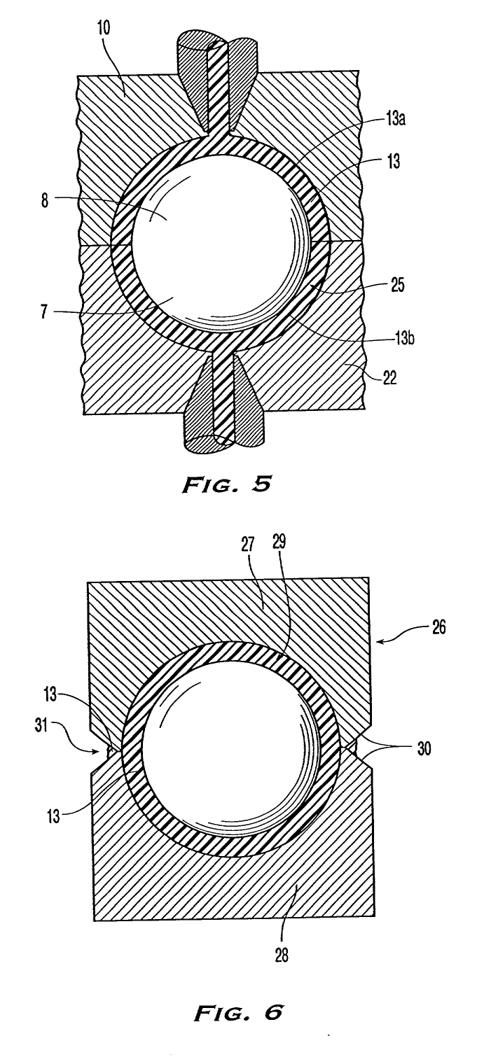

The viscosity of the injection molded layer material 13 increases quickly in the upper injection mold half 10 due to the cool temperature thereof. Once this injection molded layer material 13 is sufficiently viscous and firm to support the center 5 in a substantially fixed position, the center 5 is released from the fixture 6, and the fixture 6 is removed. In its place, a lower injection mold half 22 is pressed against the upper injection mold half 10, as shown in FIG. 4.

The lower injection mold half 22 defines a substantially hemispherical lower injection mold cavity 23. When the upper and lower mold halves 10 and 22 are brought together and closed, as shown in FIG. 4, both mold cavities 11 and 22 are substantially spherically concentric with the center 5. A lower injection cavity space 24 is defined in the lower injection mold cavity 23 between the lower injection mold half 22 and the center 5, adjoining the cooled uncured layer material 13 that is in the upper injection cavity space 20. The lower injection mold half 22 also includes at least one injection gate 12, through which the layer material 13 can be injected into the lower injection cavity space 24. Although the upper runner drop 16 is shown still received in the injection gate 12 of the upper injection mold half 10, the upper runner drop 16 may alternatively be removed from the upper injection mold half 10 when injection therein is complete.

As shown in FIG. 5, additional layer material 13 is injected into the lower injection cavity space 24 around the lower portion 7 of the center 5 to form a lower hemisphere 13b in a similar manner as was done in the upper injection cavity space 20. The layer material 13 flows in the lower injection cavity space 24 around the center 5 and contacts the upper hemisphere 13a of layer material 13. A degree of bonding occurs at this stage between the layer material 13 of the upper and lower hemispheres 13a and 13b as these hemispheres 13a and 13b come into contact. Throughout the injection molding step in the lower injection mold cavity 23, the temperatures of the upper injection mold half 10 and runner 17 are maintained similar to those in the upper injection mold half 10 when the layer material 13 was injection molded therein.

After the layer material 13 in the lower injection cavity space 24 cools, the diameter of the molded layer material 13 decreases, and the layer material 13 pulls away from the surface of the injection mold halves 10 and 22. Once the layer material 13 becomes sufficiently viscous and firm to enable its handling without substantial deformation and while supporting the center 5 concentrically therein, a golf ball core preform 25 is defined.

Referring to FIG. 6, the preform 25 is removed from the injection mold halves 10 and 22 and is placed in a compression mold 26. The compression mold 26 includes upper and lower compression mold halves 27 and 28. Together, the compression mold halves 27 and 28 define a compression mold cavity 29 which is shaped to form substantially the final outer shape of the of the mantle layer 4 of golf ball 1. The compression mold halves 27 and 28 also have tapered circumferential edges 30 that form an indented groove 31 where the compression mold haves 27 and 28 meet once they are forced together.

Once the preform 25 is in the compression mold 26, the compression mold 26 is heated to a temperature sufficient to cure or vulcanize the layer material 13, and the compression mold halves are compressed towards each other, preferably by a hydraulic press (not shown), closing the compression mold 26. With the preferred layer material 13, the compression mold is heated to a temperature sufficient to cure or vulcanize the layer material 13. This temperature is preferably more than about 300°F., and more preferably is about 330°F. The compression mold 26 is maintained at this temperature for about 10 to 15 minutes depending on the particular layer material 13 employed. Any excess layer material 13 is forced out of the compression mold cavity 29 and into the groove 31.

The compression molding of the layer material 13 around the center 5 causes crosslinking within the layer material 13 and between the hemispheres 13a and 13b of layer material 13 disposed around the lower and upper portions 7 and 8 of the center 5, fusing the hemispheres 13a and 13b together. The compression molding also relieves a significant portion of the internal stresses therein, including any that were created at weld lines between the hemispheres 13a and 13b and created by friction with the center 5 and the inner surfaces of the injection mold halves 10 and 22. Another advantage provided by the compression molding step is the better packing achieved of the layer material 13 into any shape features that the compression mold cavity 29 has, which provides a sharper finish to the molded product.

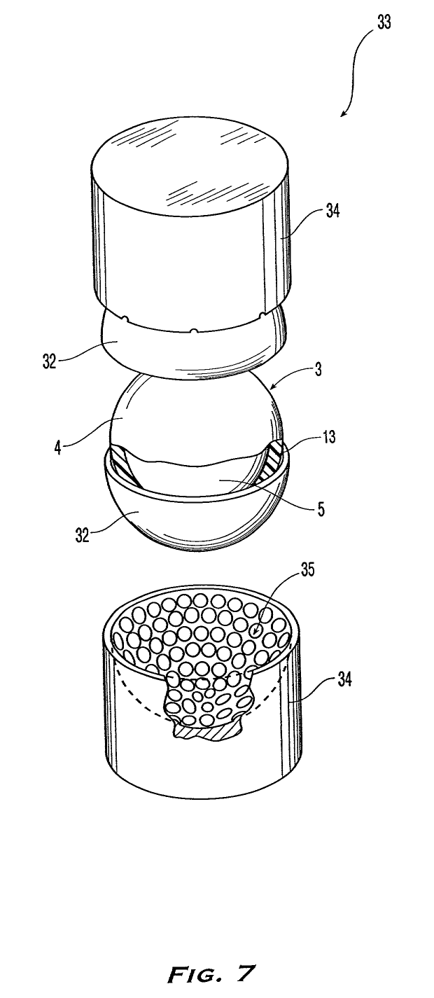

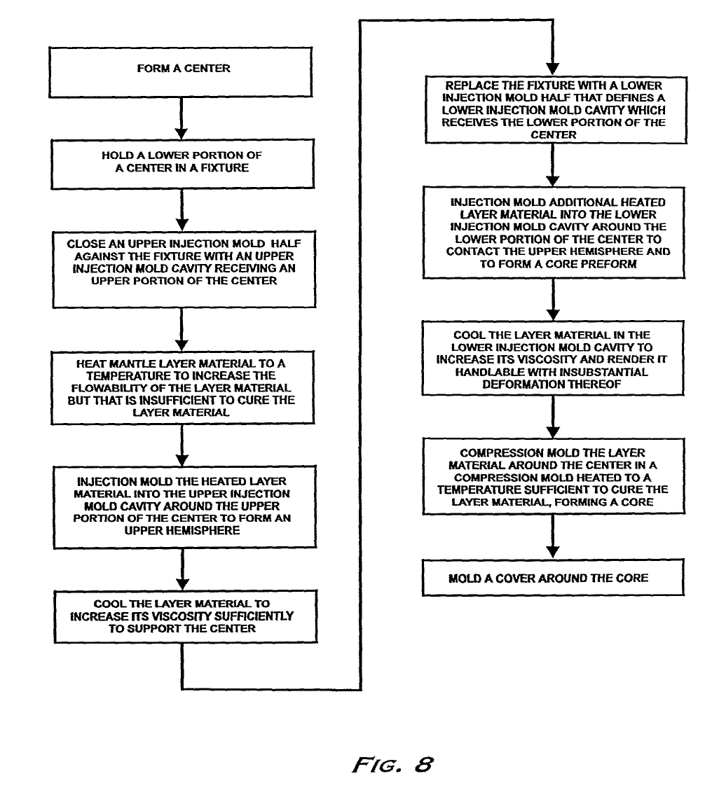

The cover 2 is molded about the core 3, including the mantle layer 4 and the center 5, in a manner known in the art. Referring to FIG. 7, preferably cover half shells 32 of a cover material are placed around the golf ball core 3. The cover material is preferably any of the cover materials commonly used in golf balls, including thermoplastic or thermoset resins, including ionomer resins, such as resins manufactured by DuPont under the trade name SURLYN®, and synthetic balata, a type of polyisoprene which is among the softest of cover materials used in modern golf balls. More particularly, the cover material can be comprised of polymeric materials such as ionic copolymers of ethylene and an unsaturated monocarboxylic acid which are available under the trademark “SURLYN” of E. I. DuPont de Nemours & Company of Wilmington, Del. or “IOTEK” or “ESCOR” from Exxon. These are copolymers or terpolymers of ethylene and methacrylic acid or acrylic acid partially neutralized with zinc, sodium, lithium, magnesium, potassium, calcium, manganese, nickel or the like.

In accordance with the preferred balls, the cover 2 has a thickness to generally provide sufficient strength, good performance characteristics and durability. Preferably, the cover 2 is of a thickness from about 0.03 inches to about 0.12 inches. More preferably, the cover 2 is about 0.04 to 0.09 inches in thickness and, most preferably, is about 0.05 to 0.085 inches in thickness.

In one preferred embodiment, the cover 2 can be formed from mixtures or blends of zinc, lithium and/or sodium ionic copolymers or terpolymers.

The Surlyn® resins for use in the cover 2 are ionic copolymers or terpolymers in which sodium, lithium or zinc salts are the reaction product of an olefin having from 2 to 8 carbon atoms and an unsaturated monocarboxylic acid having 3 to 8 carbon atoms. The carboxylic acid groups of the copolymer may be totally or partially neutralized and might include methacrylic, crotonic, maleic, fumaric or itaconic acid.

The covers of this invention may comprise homopolymeric and copolymer materials such as:

(1) Vinyl resins such as those formed by the polymerization of vinyl chloride, or by the copolymerization of vinyl chloride with vinyl acetate, acrylic esters or vinylidene chloride.

(2) Polyolefins such as polyethylene, polypropylene, polybutylene and copolymers such as ethylene methylacrylate, ethylene ethylacrylate, ethylene vinyl acetate, ethylene methacrylic or ethylene acrylic acid or propylene acrylic acid and copolymers and homopolymers produced using single-site catalyst.

(3) Polyurethanes such as those prepared from polyols and diisocyanates or polyisocyanates and those disclosed in U.S. Pat. No. 5,334,673.

(4) Polyureas such as those disclosed in U.S. Pat. No. 5,484,870.

(5) Polyamides such as poly(hexamethylene adipamide) and others prepared from diamines and dibasic acids, as well as those from amino acids such as poly(caprolactam), and blends of polyamides with Surlyn, polyethylene, ethylene copolymers, ethyl-propylene-non-conjugated diene terpolymer, etc.

(6) Acrylic resins and blends of these resins with poly vinyl chloride, elastomers, etc.

(7) Thermoplastics such as the urethanes, olefinic thermoplastic rubbers such as blends of polyolefins with ethylene-propylene-non-conjugated diene terpolymer, block copolymers of styrene and butadiene, isoprene or ethylene-butylene rubber, or copoly(ether-amide), such as PEBAX sold by ELF Atochem.

(7) Polyphenylene oxide resins, or blends of polyphenylene oxide with high impact polystyrene as sold under the trademark “Noryl” by General Electric Company, Pittsfield, Mass.

(8) Thermoplastic polyesters, such as polyethylene terephthalate, polybutylene terephthalate, polyethylene terephthalate/glycol modified and elastomers sold under the trademarks “Hytrel” by E. I. DuPont de Nemours & Company of Wilmington, Del. and “Lomod” by General Electric Company, Pittsfield, Mass.

(9) Blends and alloys, including polycarbonate with acrylonitrile butadiene styrene, polybutylene terephthalate, polyethylene terephthalate, styrene maleic anhydride, polyethylene, elastomers, etc. and polyvinyl chloride with acrylonitrile butadiene styrene or ethylene vinyl acetate or other elastomers. Blends of thermoplastic rubbers with polyethylene, propylene, polyacetal, nylon, polyesters, cellulose esters, etc.

Preferably, the cover 2 is comprised of polymers such as ethylene, propylene, butene-1 or hexane-1 based homopolymers and copolymers including functional monomers such as acrylic and methacrylic acid and fully or partially neutralized ionomer resins and their blends, methyl acrylate, methyl methacrylate homopolymers and copolymers, imidized, amino group containing polymers, polycarbonate, reinforced polyamides, polyphenylene oxide, high impact polystyrene, polyether ketone, polysulfone, poly(phenylene sulfide), acrylonitrile-butadiene, acrylic-styrene-acrylonitrile, poly(ethylene terephthalate), poly(butylene terephthalate), poly(ethelyne vinyl alcohol), poly(tetrafluoroethylene) and their copolymers including functional comonomers and blends thereof. Still further, the cover 2 is preferably comprised of a polyether or polyester thermoplastic urethane, a thermoset polyurethane, an ionomer such as acid-containing ethylene copolymer ionomers, including E/X/Y terpolymers where B is ethylene, X is an acrylate or methacrylate-based softening comonomer present in 0 to 50 weight percent and Y is acrylic or methacrylic acid present in 5 to 35 weight percent. More preferably, in a low spin rate embodiment designed for maximum distance, the acrylic or methacrylic acid is present in 15 to 35 weight percent, making the ionomer a high modulus ionomer. In a high spin embodiment, the cover includes an ionomer where an acid is present in 10 to 15 weight percent and includes a softening comonomer.

The half shells 32 and the core 3 are then placed within a conventional cover mold 33, which is preferably a compression mold. The cover mold 33 includes upper and a lower cover mold halves 34, defining dimpled cover mold cavities 35 which are shaped to form the golf ball cover 2. The cover mold halves 34 are compressed together and heated to mold and cure the half shells 32 to form the golf ball cover 2.

In an alternative embodiment, the cover 2 is molded by applying the inventive method that is described above as employed the molding of the mantle layer 4. In another embodiment, the cover 2 is purely injection molded about the core 3.

One of ordinary skill in the art can envision numerous variations and modifications. For example, the body or the layer material molded around the body may have a shape other than spherical. All of these modifications are contemplated by the true spirit and scope of the following claims.

What is claimed is:

1. A method for molding a layer around a body, the method comprising:
(a) injection molding uncured layer material around a first portion of the body to surround the first portion with the layer material and to leave a second portion of the body substantially free from the layer material;
(b) injection molding additional uncured layer material around the second portion of the body to contact the layer material around the first portion;
(c) compression molding the layer material around the body; and
(d) curing the compression molded layer material.

2. The method of claim 1, further comprising forming the body to have a substantially spherical shape, wherein the injection molding of the layer material comprises forming contacting hemispheres around the body.

3. The method of claim 1, further comprising producing the layer material from a polybutadiene based material.

4. The method of claim 1, wherein:
(a) the layer material is injection molded around the first and second portions of the body within first and second injection mold portions,
(i) the layer material being injected at a material injection temperature insufficient to cure the layer material, and
(ii) the mold portions being maintained at an injection mold temperature cold enough to increase the viscosity of the layer material such that the layer material is handlable with insubstantial deformation thereof; and
(b) the layer material is compression molded around the body within a compression mold which is heated to a compression temperature sufficient to cure the layer material.

5. The method of claim 4, further comprising:
(a) producing the layer material as a rubber; and
(b) maintaining the injection mold temperature below about 70°F.

6. The method of claim 5, wherein the compression mold temperature is at least about 300°F.

7. The method of claim 1, further comprising molding another layer about the cured layer material.

8. The method of claim 7, wherein the another layer is molded to form dimples on an outside surface thereof.

9. A method for molding a layer around a body that has first and second portions, the method comprising:
(a) locating the first portion in a predetermined position within a first mold cavity by holding the body by the second portion;
(b) injecting uncured layer material into the first mold cavity around the first portion of the body;
(c) releasing the second portion of the body;
(d) positioning the second portion of the body in a second mold cavity;
(e) injecting additional uncured layer material into the second mold cavity around the second portion of the body to contact the layer material that is disposed around the first portion of the body;
(f) compression molding the layer material about the body in a compression mold; and
(g) curing the layer material in the compression mold.

10. The method of claim 9, wherein the injecting of the layer material around the first portion of the body comprises leaving the first portion of the body unsupported.

11. The method of claim 9, wherein the second portion of the body is held in a cavity of a fixture, the cavity of the fixture being formed with a shape substantially conforming to the second portion of the body.

12. The method of claim 11, further comprising forming the first mold cavity in a first mold portion, wherein the first portion of the body is held in the predetermined position by placing the fixture against the first mold portion to substantially close the first cavity.

13. A method for molding a layer around a body, the method comprising:
(a) injection molding uncured layer material around a first portion of the body in a first injection mold cavity to surround the first portion and to leave a second portion of the body substantially free from the layer material;
(b) injection molding additional uncured layer material around the second portion in a second injection mold cavity to contact the layer material around the first portion for forming a preform;
(c) removing the preform from the injection mold cavities with the layer material still uncured; and
(d) thereafter curing the layer material around the body.

14. The method of claim 13, further comprising forming the body as an inner golf ball core layer, wherein the injection molding of the layer material around the first and second portions of the body comprises forming a golf ball mantle layer.

15. A method for molding a layer around a body, the method comprising:
(a) injection molding uncured thermoset layer material around a first portion of the body within a first injection mold portion to surround the first portion with the layer material and to leave a second portion of the body substantially free from the layer material;
(b) injection molding additional uncured thermoset layer material within a second injection mold portion around the second portion of the body to contact the layer material around the first portion;
(c) removing the body and injection molded layer material from the injection mold portions;
(d) placing the body and injection molded layer material in a compression mold; and
(e) compression molding the layer material around the body in the compression mold at a temperature sufficient to cure the layer material.

16. The method of claim 15, further comprising molding a golf ball cover about the cured layer material.
